(19) United States
(12) Patent Application Publication
(10) Pub. No.: US 2008/0297369 A1
(43) Pub. Date: Dec. 4, 2008

(54) Remote Control System with Satellite Control Devices

(75) Inventors: William B. Pittard, Los Angeles, CA (US); Duncan Wain, Palos Verdes Estates, CA (US); Scott Cernetic, Redondo Beach, CA (US)

Correspondence Address: DARBY & DARBY P.C., P.O. BOX 770, Church Street Station, New York, NY, 10008-0770, US

(73) Assignee: Scope Seven Inc., El Segundo, CA (US)

(21) Appl. No.: 11/577,013

(22) PCT Filed: Oct. 11, 2005
(86) PCT No.: PCT/US05/36916

§ 371 Date: Aug. 13, 2007

Related U.S. Application Data
(60) Provisional application No. 60/618,242, filed on Oct. 12, 2004.

(30) Foreign Application Priority Data
Feb. 1, 2005 (US) PCT/US05/02843

(51) Int. Cl. G05B 19/04

(52) U.S. Cl. 340/825.22

(57) ABSTRACT

A remote control system including a primary remote control (20) in communication with one or more secondary remote controls (30-38) that each have one or more secondary input keys (22b-c, 24b-c, 26b-c, 28b-c), are that dynamically associated with programmed operation of a DVD player (40), computer, or other electronic device. Upon activation of a secondary input key, the primary remote control receives an input signal and determines a code associated with the activated key. The code may also be associated with a primary input key (22a, 24a, 26a, 28a, 23, 25, 27) on the primary remote control. The primary and secondary input keys may have the same color, shape, or other characteristics. The code is communicated to the electronic device to perform the programmed operation concurrently associated with the code. The programmed operation may also be associated with a display icon that may have the same characteristics as the input keys. The secondary remote controls enable multiple users to command the electronic device.

### CROSS-REFERENCE TO RELATED APPLICATIONS

This application claims the benefit of U.S. Provisional Patent Application 60/618,242 filed Oct. 12, 2004, and to International Patent Application PCT/US2005/002843, filed Feb. 1, 2005, which claims priority to U.S. Provisional Patent Application 60/541,466 filed Feb. 2, 2004, the contents of all of which are hereby incorporated by reference.

### FIELD OF ART

The present invention relates generally to a remote control system, and more particularly to a remote control with multiple secondary controls that enable peripheral keys to act through the remote control to communicate with a receiver.

### BACKGROUND

Televisions, digital versatile disc (DVD) players, audio equipment, and other electronic devices, often include a wireless remote control with multiple keys to control a corresponding electronic device and/or media running on the electronic device. These remote controls are generally designed for use by one person at a time. A different person who wishes to participate in controlling the electronic device and/or the media running on the electronic device usually obtains the single remote control from the previous user. Many remote controls are sized to be held in one hand, and include very small keys. It is impractical for multiple users to interact with the very small keys on small remote controls at the same time.

### BRIEF DESCRIPTION OF THE DRAWINGS

FIG. 1 illustrates a remote control system with a central remote control and satellite control devices according to one embodiment of the invention;

FIG. 2 is a functional block diagram of a central remote control according to one embodiment of the invention;

FIG. 3 is a functional block diagram of a satellite control according to one embodiment of the invention; and

FIG. 4 is a flow diagram illustrating exemplary logic of a central remote control for communicating a command from a satellite control to an electronic device.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as devices or methods. Accordingly, the present invention may take the form of an entirely hardware embodiment or an embodiment combining software and hardware aspects. The following detailed description is, therefore, not to be taken in a limiting sense.

### Illustrative Remote Control System

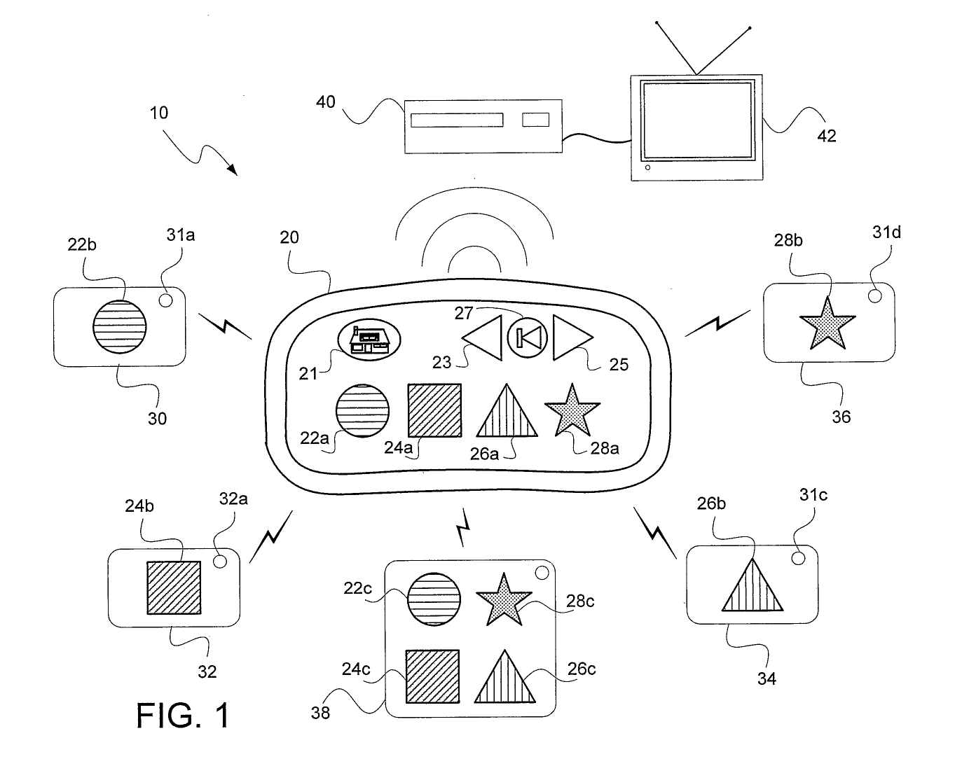

FIG. 1 illustrates a remote control system 10 with a central remote control 20 and secondary or satellite control devices 30-38 according to one embodiment of the invention. Central remote control 20 communicates with an electronic device 40, such as a DVD player, video cassette recorder (VCR), a DVD drive, or the like. The communication can be wired or wireless, such as infrared (IR), radio frequency (RF), and the like. Electronic device 40 communicates with, or is integrated with, a display 42, such as a television, a computer monitor, or the like.

Central remote control 20 is illustrated as a simplified remote control device with a minimum set of keys, but can be configured with any number of keys. Central remote control 20 is shown with a number of keys 21-28a that can be easily understood and activated by a child user. Some of the keys can be consistent navigation keys, such as a home key 21, a back key 23, a forward key 25, a repeat key 27, and the like. Other keys can be direct-select keys 22a-28a that can be dynamically associated with operations defined by software stored on a media disc and executed by electronic device 40. Direct-select keys 22a-28a can each have a different shape and/or color for easy identification by a user. Each shape and/or color can also correspond to one operation, one game answer, or another option provided by software stored on media and played by electronic device 40.

Satellite control devices 30-38 can include duplicates of one or more of the keys on central remote control 20. A plurality of users can then interact with electronic device 40 through central remote control 20. For example, satellite control 30 can include a satellite key 22b that is the same shape and color as direct-select key 22a. A user can depress satellite key 22b to cause central remote control 20 to send a signal that corresponds to direct-select key 22a. Similarly, satellite control devices 32-36 can include satellite keys 24b-28b that correspond to direct-select keys 24a-28a, respectively. The satellite control devices can also include a non-duplicate key.

Alternatively, or in addition, a satellite control can include multiple keys. For instance, satellite control 38 includes multiple satellite keys 22c-28c that correspond to direct-select keys 22a-28a. Satellite control 38 can be made large enough for access and use by multiple people around satellite control 38. Conversely, each user can have a satellite control with multiple keys, enabling each user to choose from multiple selections and/or operations. Other keys can be provided on the satellite controls, or different sets of satellite controls can be provided for different purposes. For instance, an interactive DVD game may require each player to answer Yes or No to displayed questions. Two keys on each satellite control can be used as Yes and No keys. Alternatively, or in addition, an interactive media system may require the users to use multiple directional arrows.

The satellite control devices can also include indicator lights 31a-31d, small displays, and/or other components. Indicator lights 31a-31d can be used to indicate when a user has activated a satellite key. Alternatively, or in addition, the indicator lights can be used to indicate which user first activated a satellite key. This first user indication may require communication from remote control 20 and/or communication among the satellite devices.

Each satellite control device communicates with central remote control 20. The communication can be wired or wireless, such as infrared (IR), radio frequency (RF), and the like. If wireless communication is used by the satellite control devices to communicate with the central remote control, and wireless communication is used by the central remote control to communicate with the electronic device, the forms of wireless communication, the frequencies, and/or the communication protocols, should be different from each other. For example, central remote control 20 may communicate with the electronic device via infrared signals, and satellite controls 30-38 may communicate with central remote control 20 via RF signals. Each satellite control device can communicate over a separate frequency, so that central remote control 20 can identify each satellite control device.

Central remote control 20 may be used as an additional specialized remote control for an electronic device, in addition to a conventional remote control that might come with the electronic device. Thus, central remote control 20 can be programmed to operate with any particular device. In this embodiment, there is no need for the user to program any of the satellite control devices, because the satellite control devices communicate with the central remote control and the central remote control converts the received RF signals to IR signals that are readable by the electronic device. Nevertheless, another embodiment of the satellite control devices could be configured to communicate directly with the electronic device, which may require programming of the satellite control devices.

### Illustrative Architectures

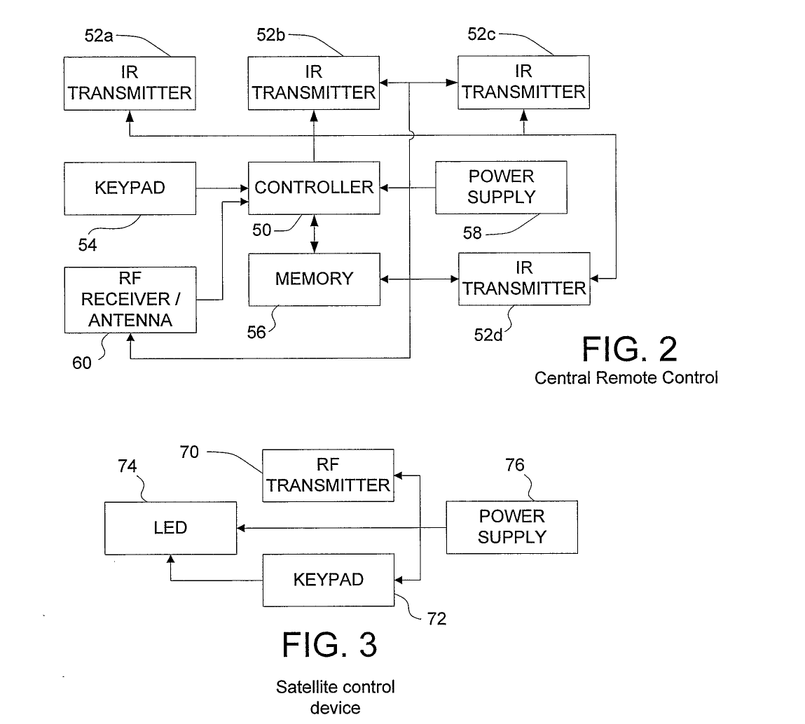

FIG. 2 is a functional block diagram of an exemplary central remote control, according to one embodiment of the invention. The central remote control may include many more components than those shown. The components shown, however, are sufficient to disclose an illustrative embodiment for practicing the invention. The central remote control includes a controller 50 that coordinates remote control processes. Controller 50 is in communication with transmitters 52a-52d. The transmitters can be connected in serial or parallel, but are shown in parallel such that failure of one transmitter will not affect the remaining transmitters. Multiple transmitters may be used around the central remote control to ensure that a signal is communicated to the receiving electronic device if one of the transmitters is obstructed or misaligned from the receiving electronic device. Controller 50 is also in communication with a keypad 54, which can include multiple types of keys on multiple faces of the central remote control. A memory 56 provides permanent and temporary storage for controller 50. A power supply 58, such as a battery, provides power to other components of the central remote control.

Controller 50 also communicates with an RF receiver 60, which receives signals at a different frequency from each of the satellite controls. RF receiver 60 can include an analog-to-digital converter and/or other circuitry to facilitate communication between RF receiver 60 and controller 50. RF receiver 60 wirelessly communicates with the satellite controls according to an RF protocol such as Bluetooth™, Institute of Electrical and Electronic Engineers (IEEE) 802.11, IEEE 802.16 (WiMax), and the like. In an alternate embodiment, RF receiver 60 could be replaced with a transceiver that can also transmit signals to the satellite control devices. This transmission capability may be used to instruct a satellite control device to stop further transmissions for a period of time, to illuminate an indicator light, and/or other operations. If a wired configuration is used, RF receiver 60 could be replaced by a wired communication interface, such as a universal serial bus (USB) interface that could be configured for uni-directional or bi-directional communication with satellite control devices.

FIG. 3 is a functional block diagram of an exemplary satellite control device, according to one embodiment of the invention. The satellite control device may include many more components than those shown. The components shown, however, are sufficient to disclose an illustrative embodiment for practicing the invention. This embodiment of the satellite control device includes at least one RF transmitter 70 that can transmit an RF signal according to the RF protocol required by the central remote control. In an alternate embodiment, RF transmitter 70 could be replaced with a transceiver that can also receive signals from the central remote control. Similarly, if a wired configuration is used, RF transmitter 70 could be replaced by a wired communication interface. An IR transmitter (not shown) or other type of transmitter may be used.

RF transmitter 70 is in communication with a keypad 72 that can comprise one or more satellite keys, as discussed above. When RF transmitter 70 detects that a satellite key is depressed, a signal corresponding to the depressed satellite key is transmitted from RF transmitter 70 to the central remote control. Keypad 72 can also communicate a signal to a light emitting diode (LED) 74, causing LED 74 to illuminate. LED 74 could alternatively be driven by RF transmitter 70 or a corresponding transceiver. Alternatively, or in addition, a noise generator, such as a buzzer, can be included to communicate with the keypad and/or RF transmitter. A power supply 76, such as a battery, provides power to other components of the satellite control device.

The satellite control device could also include a controller to coordinate the other components. Each satellite control device could be configured to send key codes alone, or key codes followed by an “enter” code. However, this additional complexity may not be needed for the satellite control devices if the central remote control can be configured to add a following “enter” code if necessary.

### Illustrative Logic

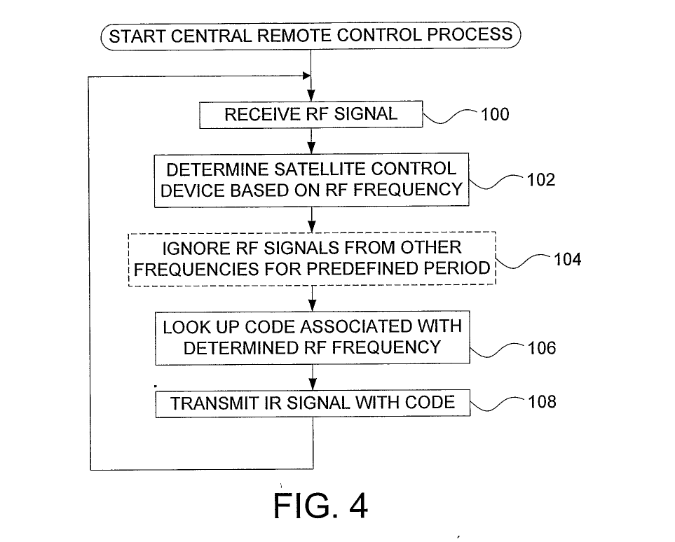

FIG. 4 is a flow diagram illustrating exemplary logic of the central remote control for communicating a command from a satellite control to an electronic device. This exemplary logic detects a first signal from one of the satellite control devices, wherein the satellite control devices are used in a multiplayer game and the fastest player's satellite control device is detected. At an operation 100, the central remote control receives a signal from the first satellite remote control to send a signal. The central remote control determines which satellite control device sent the signal at an operation 102, based on the frequency of the signal. When one or more of the satellite control devices includes multiple keys, the central remote control may further determine which key was depressed, based on a combination of the frequency and a code value sent in the signal. Once the sending satellite control device has been identified, the central remote control can optionally lockout, or otherwise ignore, subsequent signals from other satellite control devices, as illustrated by optional operation 104. This optional lockout can be implemented for a predetermined period of time or until another event is detected, such as pressing a “next” key on the central remote control, that might cause the electronic device to display a next question. In addition, or alternatively, software executed by the receiving electronic device, such as a DVD player, can lock out, or ignore subsequent signals for a predetermined period, or until another operation is detected.

Based on the frequency of the received signal, the central remote control looks up a number key code at an operation 106. The frequency of each satellite control device can be associated with a specific code, such as a number key code, and stored as a look-up table in the memory of the central remote control. Similarly, a set of codes can be associated with each frequency, if each satellite control device includes multiple keys. A specific code can be determined by the frequency and code value sent in the signal. At an operation 108, the central remote control transmits the determined code to the desired electronic device, such as a DVD player. If appropriately configured for a given electronic device, the central remote control can subsequently transmit an “enter” code. The electronic device need not recognize that the signal originated from a satellite control device. Instead, the electronic device may simply act on the received code as if it had originated from the central remote control. For example, a DVD player could execute a software operation that is dynamically associated with the specific code in accord with an industry standard DVD-Video specification. This would enable multiple users to interact with a game or other DVD-Video media. After a code is transmitted to the electronic device, logic control returns to operation 100 to await another signal from a satellite control device.

The above specification, examples and data provide a complete description of the manufacture and use of the composition of the invention, although many other embodiments are possible. For example, the central and/or satellite remote control devices can be adapted to control access to markup language content through a network. The central and/or satellite remote control devices could be used in place of a keyboard and/or mouse, for easier use by children, seniors, and/or disabled users. Since many embodiments of the invention can be made without departing from the spirit and scope of the invention, the invention resides in the claims hereinafter appended.

What is claimed as new and desired to be protected by Letters Patent is:

1. A remote control system comprising:
a secondary remote control including a secondary input key and a secondary communication interface that transmits an input signal in response to activation of the secondary input key; and
a primary remote control including a primary input key and a primary communication interface that receives the input signal and transmits a command signal to an electronic device based on the input signal, wherein the command signal is associated with both the secondary input key and the primary input key.

2. The remote control system of claim 1, wherein the secondary input key and the primary input key are both associated with a display element that is dynamically associated with a programmed operation of the electronic device.

3. The remote control system of claim 1, wherein:
the secondary communication interface comprises one of the following; a wireless communication interface and a wired communication interface; and
the primary communication interface comprises one of the following; a wireless communication interface and a wired communication interface.

4. The remote control system of claim 1, wherein the secondary input key and the primary input key share an equivalent configuration.

5. The remote control system of claim 1, wherein:
the secondary remote control includes another secondary input key, which causes the secondary communication interface to transmit a different input signal in response to activation of the other secondary input key; and
the primary remote control includes another primary input key that is associated with the other secondary input key, and wherein the primary communication interface receives the different input signal and transmits a different command signal to the electronic device based on the different input signal, and wherein the different command signal is associated with both the other secondary input key and the other primary input key.

6. The remote control system of claim 1, further comprising another secondary remote control including a different secondary input key and including another secondary communication interface that transmits a different input signal in response to activation of the other secondary input key, and wherein the primary remote control includes another primary input key that is associated with the other secondary input key, and wherein the primary communication interface receives the different input signal and transmits a different command signal to the electronic device based on the different input signal, and wherein the different command signal is associated with both the other secondary input key and the other primary input key.

7. The remote control system of claim 1, wherein the primary remote control identifies the secondary remote control based on a frequency of the input signal.

8. The remote control system of claim 1, wherein the primary remote control determines a code associated with the input signal and communicates the code in the command signal to the electronic device.

9. The remote control system of claim 1, wherein the command signal conforms to a digital versatile disc (DVD) video specification.

10. The remote control system of claim 1, wherein the command signal is associated with one of the following; a navigation operation and a direct select operation.

11. The remote control system of claim 1, wherein the secondary remote control further includes at least one of:
a display device for displaying information including an indication that the secondary input key was activated; and
an audio device for producing sounds including an indication that the secondary input key was activated.

12. A method for transmitting a command signal to a controlled electronic device, comprising:
receiving an input signal from a secondary remote control that includes a secondary input key and a secondary communication interface that transmits the input signal in response to activation of the secondary input key; and
transmitting a command signal to an electronic device, wherein the command signal is based on the input signal and is associated with both the secondary input key and a primary input key of a primary remote control.

13. The method of claim 12, wherein the command signal instructs the electronic device to perform a programmed operation that is dynamically associated with a display element, which shares a configuration with the secondary input key and the primary input key.

14. The method of claim 12, further comprising identifying the secondary remote control from among a plurality of secondary remote controls that are in communication with the primary remote control.

15. The method of claim 12, further comprising:
determining a code associated with the secondary input key and the primary input key; and
communicating the code in the command signal.

16. The method of claim 12, wherein the command signal conforms to a digital versatile disc (DVD) video specification.

17. A machine readable medium storing data and instructions that cause the remote control device to perform the operations of claim 12.

18. A remote control system comprising:
a secondary remote control including a secondary input key and a secondary communication interface that transmits an input signal in response to activation of the input key; and
a primary remote control including a primary communication interface that receives the input signal and transmits a command signal to an electronic device, wherein the command signal is based on the input signal and is associated with the secondary input key, and wherein the secondary input key is associated with a display element that is dynamically associated with a programmed operation of the electronic device.

19. The remote control system of claim 18, wherein the secondary input key and the primary input key share a configuration with the display element.

20. The remote control system of claim 18, wherein the primary remote control identifies the secondary remote control and communicates the identity in the command signal to the electronic device.
